(19) United States
(12) Patent Application Publication
(10) Pub. No.: US 2025/0200404 A1
(43) Pub. Date: Jun. 19, 2025

(54) METHOD AND DEVICES OF AN EFFICIENT GAUSSIAN MIXTURE MODEL (GMM) DISTRIBUTION BASED APPROXIMATION OF A COLLECTION OF MULTI-DIMENSIONAL NUMERIC ARRAYS IN A COMPUTING ENVIRONMENT

(71) Applicants: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(72) Inventors: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(21) Appl. No.: 18/544,405

(22) Filed: Dec. 18, 2023

(51) Int. Cl. G06N 7/01

(52) U.S. Cl. CPC G06N 7/01

(57) ABSTRACT

Disclosed are a method and devices of an efficient Gaussian Mixture Model (GMM) distribution based approximation of a data set including a collection of multi-dimensional numeric arrays in a computing environment. In accordance therewith, the data set is distributed across a multi-dimensional grid having integer coordinates associated therewith, and a hypercube is assigned to each constituent Gaussian distribution of constituent Gaussian distributions of the GMM distribution as a subspace of the multi-dimensional grid to form a number of hypercubes. A data footprint of the data set is reduced through the GMM distribution based on assigning the hypercube to the each constituent Gaussian distribution of the constituent Gaussian distributions of the GMM distribution.

### FIELD OF TECHNOLOGY

This disclosure relates generally to big data processing and, more particularly, to a method and/or devices of an efficient Gaussian Mixture Model (GMM) distribution based approximation of a collection of multi-dimensional numeric arrays in a computing environment.

### BACKGROUND

A computing environment may involve processing large data sets including large volumes of and/or complex data. The computing environment may, for example, be a Machine Learning (ML) environment involving large data sets. The data set may, for example, include multi-dimensional numeric arrays that are obtained from image data, video data and/or time-series data of sensor measurements. While a probabilistic model such as a Gaussian Mixture Model (GMM) may represent a data set including numeric values by assuming that all data points therewithin are generated from a mixture of a finite number of Gaussian distributions, application of representational models to the aforementioned multi-dimensional numeric arrays may be extremely complex and/or computationally difficult.

### SUMMARY

Disclosed are a method and/or devices of an efficient Gaussian Mixture Model (GMM) distribution based approximation of a collection of multi-dimensional numeric arrays in a computing environment.

In one aspect, a method of approximating a data set including a collection of multi-dimensional numeric arrays with a Gaussian Mixture Model (GMM) distribution using a processor communicatively coupled to a memory is disclosed. The method includes distributing the data set across a multi-dimensional grid having integer coordinates associated therewith, and assigning a hypercube to each constituent Gaussian distribution of constituent Gaussian distributions of the GMM distribution as a subspace of the multi-dimensional grid to form a number of hypercubes. The method also includes reducing a data footprint of the data set through the GMM distribution based on assigning the hypercube to the each constituent Gaussian distribution of the constituent Gaussian distributions of the GMM distribution.

In another aspect, a data processing device to approximate a data set including a collection of multi-dimensional numeric arrays with a GMM distribution is disclosed. The data processing device includes a memory and a processor communicatively coupled to the memory. The processor executes instructions to distribute the data set across a multi-dimensional grid having integer coordinates associated therewith, and to assign a hypercube to each constituent Gaussian distribution of constituent Gaussian distributions of the GMM distribution as a subspace of the multi-dimensional grid to form a number of hypercubes. The processor also executes instructions to reduce a data footprint of the data set through the GMM distribution based on assigning the hypercube to the each constituent Gaussian distribution of the constituent Gaussian distributions of the GMM distribution.

In yet another aspect, a data processing device to approximate a data set including a collection of multi-dimensional numeric arrays is disclosed. The data processing device includes a memory, and a processor communicatively coupled to the memory. The processor executes instructions to distribute the data set across a multi-dimensional grid having integer coordinates associated therewith, and to assign a hypercube to each constituent Gaussian distribution of constituent Gaussian distributions of a GMM distribution as a subspace of the multi-dimensional grid to form a number of hypercubes. The processor also executes instructions to utilize the GMM distribution to approximate the data set, and to utilize the GMM distribution along with or instead of the data set for a computational operation using a Machine Learning (ML) algorithm also executing on the processor.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing system, according to one or more embodiments.

FIG. 2 is a schematic view of a collection of multi-dimensional numeric arrays of the input data of the computing system of FIG. 1 in terms of a Gaussian Mixture Model (GMM) distribution thereof, according to one or more embodiments.

FIG. 3 is a schematic view of derivation of the GMM distribution of FIGS. 1-2 from the collection of multi-dimensional numeric arrays of the input data of the computing system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method and/or devices of an efficient Gaussian Mixture Model (GMM) distribution based approximation of a collection of multi-dimensional numeric arrays in a computing environment. Although the present embodiments have been described with reference to specific example embodiments, it will be evident that various modifications and changes may be made to these embodiments without departing from the broader spirit and scope of the various embodiments.

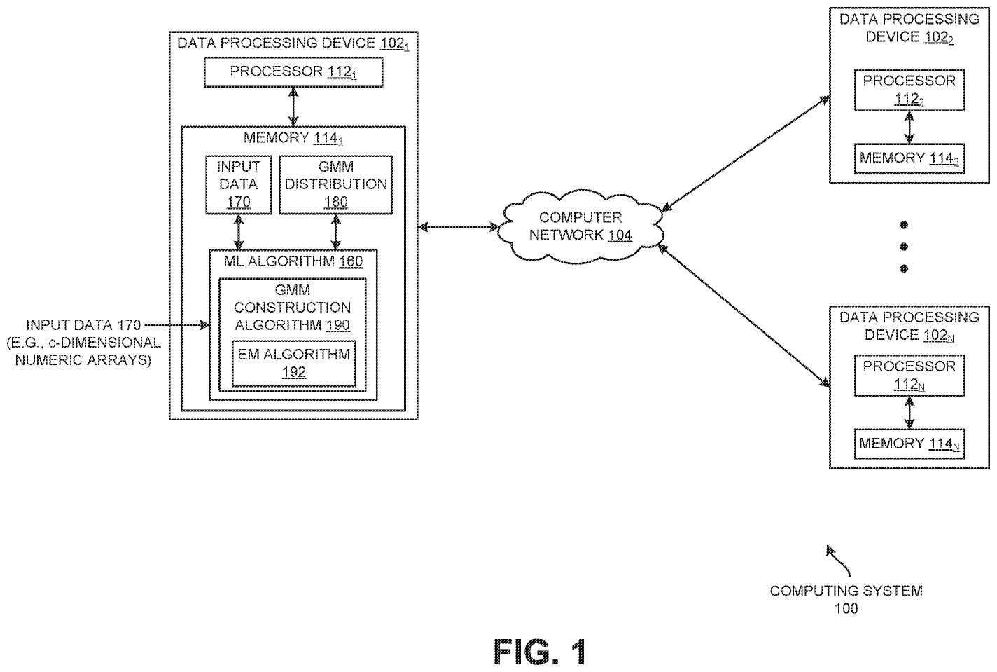

FIG. 1 shows a computing system 100, according to one or more embodiments. In one or more embodiments, computing system 100 may include a number of data processing devices 102_{1-N} communicatively coupled to one another through a computer network 104 (e.g., a Local Area Network (LAN), a Wide Area Network (WAN), the Internet, a short-range network based on Bluetooth®, WiFi® and the like). It should be noted that while exemplary embodiments have been placed within the context of computing system 100, concepts discussed herein may be applicable to a standalone data processing device 102_{1-N} of computing system 100. In one or more embodiments, data processing devices 102_{1-N} may include one or more server(s), one or more client device(s) and/or one or more portable computing devices (e.g., mobile phones, smart devices). In one or more embodiments, data processing devices 102_{1-N} of computing system 100 may constitute a distributed (e.g., across a cloud) network of data processing devices, a cluster of data processing devices and/or a hybrid network of data processing devices. All reasonable variations are within the scope of the exemplary embodiments discussed herein.

As shown in FIG. 1, in one or more embodiments, each data processing device 102_{1-N} may include a processor 112_{1-N} (e.g., a standalone processor, a network/cluster of processors) communicatively coupled to a memory 114_{1-N} (e.g., a volatile and/or a non-volatile memory). For example, data processing device 102₁ may implement a Machine Learning (ML) algorithm 160 therein. It should be noted that ML algorithm 160 may be implemented across more than one data processing device 102_{1-N} of computing system 100. However, ML algorithm 160 has been shown as executing solely on data processing device 102₁ (e.g., stored in memory 114₁ and executing on processor 112₁) merely for the sake of example. In one or more embodiments, ML algorithm 160 itself may include a set of algorithms.

FIG. 1 shows input data 170 to ML algorithm 160, according to one or more embodiments. In one or more embodiments, input data 170 may be collections of more complex elements than simple numeric values. For example, input data 170 may be a collection of two-dimensional (or c-dimensional, where c>2) tensors (or, numeric arrays in general) that may be a result of transformation of a collection of images thereinto, one tensor per image. A numeric array may store information about an intensity of occurrence of an important pattern at different coordinates of an image. Thus, when input data 170 is in tabular form, numeric values of some columns of a table constituting input data 170 may not be single numbers but arrays of numbers (e.g., two-dimensional arrays for images; higher dimensional (e.g., c-dimensional, where c>2) may be possible in the case of videos and/or time-series data).

Tensors may offer a good and consistent description of space and time and may often be used to represent image, audio, video and/or spatio-temporal data sets, as well as multi-dimensional sensory (e.g., results of sensor measurements) data sets, in avenues ranging from patient monitoring during pre- and/or post-operative care, satellite object recognition to intelligent vehicular systems. The multi-dimensionality of tensors may enable formal storage of a substantially large amount of information. In the quest for achieving a balance between effective compression and decomposition methods to reduce the size of input data 170 on the one hand and retention of key information as much as possible on the other, tensors may, for example, store images in the form of coordinates, information about RGB colors and/or grayscale and all bands thereof.

Apache Parquet™, typically used to effectively store big data in a compressed form, may store data in a column-oriented file format. While a tensor data type may not be natively supported, built-in data types in Apache Parquet™ may help organize input data 170 in several appropriate ways. Apache Parquet™ may store input data 170 in the form of collections of data packs that allow for fast and efficient access to particular data groups at levels of sets of data columns or even groups within single data columns.

Tensors may help better organize space and increase efficiency of subsequent processing of input data; said subsequent processing may also involve training ML algorithm 160. Compressing said tensors may also lead to effective creation, storage and processing of tensors. A highly efficient use of tensors may require extract and subsequent processing of the sensors; an example of an application requiring highly efficient use of tensors may involve fast and accurate training of ML models (e.g., those implemented in ML algorithm 160). Efficient storage creation for the tensors may also be important.

As indicated above, input data 170, when represented by the tensor data type, may be typically multi-dimensional and, therefore, of a large size. The large size may lead to contexts in which analysis of input data 170 may become laborious and/or resource-intensive. In one or more embodiments, by way of tensor decomposition, quintessential information from the tensors may be extracted while significantly reducing the size of input data 170. While tensor decomposition may be lossy, it may be possible to recover the original data in every case. An example type of tensor decomposition may be Canonical Polyadic (CP) Decomposition. Every matrix (with dimensionality 2) may be expressed as a sum of the outer product of two vectors. Likewise, a three-dimensional tensor may be expressed as the sum of outer products of three vectors. To generalize, an c-dimensional tensor may be expressed as the sum of outer products of c vectors, which may be regarded as a Kruskal form of a tensor.

Thus, the CP decomposition may provide the sum of one-dimensional tensors that are composed into matrix columns. For every mode of the tensor, there may exactly one such matrix. The rank parameter may be responsible for the number of components in the abovementioned sum. Another example type of tensor decomposition may be the Tucker decomposition. If the Kruskal form discussed above is generalized, for a tensor, the projection of every matrix for each mode thereof may be taken along with a core tensor to express said tensor. The resultant Kruskal tensor with a super diagonal score may be called a Tucker tensor. The rank may be a dimensionality of the core tensor, whereby the number of dimensions is the same as in the original tensor, but the number of elements per dimension is reduced. The greater the rank, the more accurate may be the resultant tensor in terms of reducibility to the original tensor. However, the resultant Tucker tensor may take a longer while to be computed and may take up more memory (e.g., memory 114₁) space.

In most cases, however, the classification quality of ML models (e.g., implemented in ML algorithm 160) based on the Tucker decomposition may be sufficiently (e.g., at least 85%) close to the original source tensors while the execution times of operations associated therewith may be significantly reduced. With a shorter execution time of the operations accompanied by the sufficient closeness of the ML models in terms of accuracy to the original source tensors, available disk space in memory 114₁ may be better organized while essential information of the original source tensors may be preserved. It should be noted that, in some cases, the quality of the models (e.g., ML models) based on the Tucker decomposition may be even better than the models for the original source data.

In another context, an autoencoder neural network may be a type of an unsupervised learning model (e.g., implemented through ML algorithm 160) that aims to learn an efficient representation of input data thereto by encoding said input data into a lower-dimensional, compact representation termed a latent space. Learning how to reconstruct the input data from this latent space may involve capturing the most important features and the patterns present in the original data. A standard autoencoder may include an encoder and a decoder. The encoder may take an input and map said input to a compressed representation thereof in the latent space using a series of neural network layers. The decoder may take the compressed representation in the latent space and attempt to reconstruct the original input. The goal in an autoencoder implementation may be to minimize the difference between the input and the representation thereof; the difference may be measured using a loss function based on, say, mean squared error.

Variational autoencoders (VAEs) may take the concept of an autoencoder further by adding a probabilistic Bayesian interpretation. In the case of VAEs, the encoder may generate a Gaussian probability distribution over possible latent representations thereof. This may allow for more flexibility in capturing the underlying structure of the data therein. The decoder may then try to reconstruct the input based on a sample drawn from this generated Gaussian probability distribution. The training process may involve maximizing the likelihood of the input given the latent space distribution, and may often employ techniques such as reparameterization. By training a VAE, new data samples that are similar to the training data samples may be obtained.

VAE based models may find use in fields such as computer vision and Natural Language Processing (NLP). The encoder of the VAE may not only generate a mean vector but also generate a standard deviation vector for each sample in the dataset. The standard deviation vector may enable sampling from a Gaussian distribution using reparameterization. By sampling multiple vectors from the distribution, diverse latent space representations may be generated. Similar to an autoencoder, a VAE may use a decoder to reconstruct the input from the sampled latent space. However, the VAE may incorporate a regularizer known as the Kullback-Leibler (KL) divergence into a loss function thereof to ensure that the latent space distributions are close to a standard Gaussian distribution. This may help in regularization and may lead to generation of smooth and continuous samples.

During training, the VAE may attempt to minimize the reconstruction loss that relates to how well the decoder can replicate the original input. Additionally, the VAE may aim to minimize the KL divergence loss that relates to the similarity between the learned latent space distribution and the standard Gaussian distribution. Wasserstein variational autoencoders (WVAs) build upon VAEs by incorporating a Wasserstein distance, also known as the Earth Mover's Distance, as a measure of distance between probability distributions. The Wasserstein distance may provide a more robust and stable training objective compared to traditional metrics such as the KL divergence. By minimizing this distance, WVAs may aim to improve the quality of the generated samples and capture the underlying data distribution more accurately.

A probabilistic model such as a Gaussian Mixture Model (GMM) may assume that all data points within large data sets are generated from a mixture of a finite number of Gaussian distributions. The GMM may enable clustering of data points within the large data sets. In case of Gaussian Mixture Models (GMMs), it may be possible to design a VAE such that a list of different pairs of mean and standard deviation vectors is generated. The VAE may try to model the latent space using a GMM. Based on this approach, it may be possible to apply GMM/GMMs to various types of data such as image data and/or audio data that are extremely difficult to model using GMMs without deep pre-processing. It is to be noted that standard GMMs may only model the distribution over the input space, while VAEs may create a latent space such that it is possible to embed Gaussian distribution parameters therewithin. This latent space may strictly correspond to weights associated with the encoder and the decoder; said weights, for example, may be computed using the gradient descent algorithm. Meanwhile, GMMs may be estimated using an Expectation-Maximization (EM) algorithm.

Thus, exemplary embodiments may take the result of a transformation (e.g., a tensor-based transformation) of a collection of images, video data and/or complex time-series (e.g., sensor) data, i.e., multi-dimensional numeric arrays (e.g., c-dimensional tensors, where c≥2) as input data 170 and apply a GMM to approximate a distribution thereof to further reduce a data footprint of input data 170. In one or more embodiments, the multi-dimensional numeric arrays constituting input data 170 may also be an output of an autoencoder discussed above; here too, the data footprint of input data 170 may be reduced based on application of the GMM. Other sources of input data 170 are within the scope of the exemplary embodiments discussed herein.

In one or more embodiments, in the case of input data 170 in a tabular form including multiple data columns, each column may be an array of elements of numeric values, where the elements may be single numeric values or vectors of numeric values. Here, in one or more embodiments, a GMM construction algorithm 190 (e.g., part of ML algorithm 160; GMM construction algorithm 190 may also be distinct from ML algorithm 160 and associated therewith) may be applied to input data 170 to generate a GMM distribution 180 (e.g., shown stored in memory 114₁) that approximates input data 170. In other words, the input to GMM construction algorithm 190 by way of input data 170 may be dimensional and values of single dimensions may be vectors or arrays.

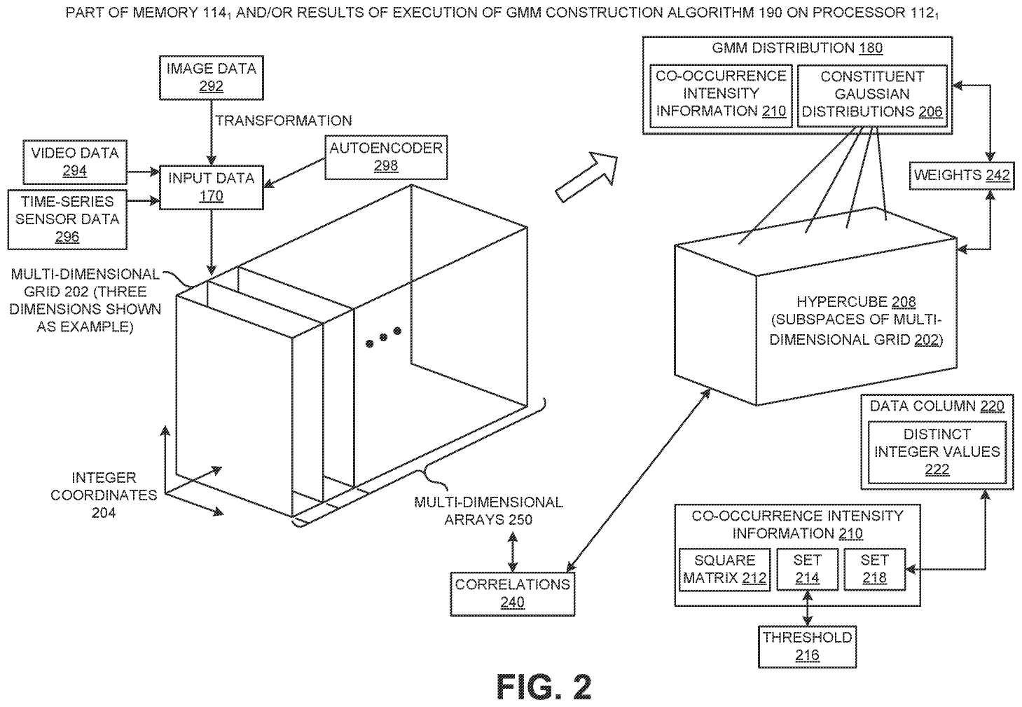

FIG. 2 shows input data 170 along with a schematic thereof in terms of GMM distribution 180, according to one or more embodiments. In one or more embodiments, input data 170 may be regarded to be a collection of multi-dimensional arrays 250 distributed across a multi-dimensional grid 202 having integer coordinates 204. A three-dimensional grid representation of multi-dimensional grid 202 is merely shown for example purposes in FIG. 2. In one or more embodiments, as GMM distribution 180 may include a number of constituent Gaussian distributions 206, each constituent Gaussian distribution 206 may be assigned a hypercube 208 (e.g., of hypercubes 208), which is a subspace of multi-dimensional grid 202, within which activity thereof may be established. Here, in one or more embodiments, the subspace of hypercube 208 may refer to a vector space entirely contained within multi-dimensional grid 202.

In one or more embodiments, correlation (e.g., correlations 240) between intensities of occurrence (e.g., related to fuzziness) of numeric values likely to be derived from a given (or, a specific) constituent Gaussian distribution 206 and specific integer coordinates 204 thereof within the assigned hypercube 208 may be represented based on regarding the numeric values that are likely to be derived from the given constituent Gaussian distribution 206 as occurring in an entirety of the corresponding hypercube 208 assigned thereto. In one or more embodiments, the aforementioned correlation 240 May also be represented based on a set of hypercubes 208 forming a chain of consecutive subsets thereof being assigned to the same constituent Gaussian distribution 206, but with different weights (e.g., weights 242). Further, in one or more embodiments, the correlation (e.g., correlation 240) may be represented based on regarding the given constituent Gaussian distribution 206 as a multi-dimensional Gaussian distribution, whereby integer coordinates 204 thereof are regarded as additional numeric dimensions.

In one or more embodiments, GMM distribution 180 may additionally include information (e.g., co-occurrence intensity information 210) related to an intensity of co-occurrence and/or a lack of co-occurrence of numeric values that are likely to be derived from different constituent Gaussian distributions 206 at different integer coordinates 204 within a same array 250 of the collection of multi-dimensional arrays 250. In one or more embodiments, co-occurrence intensity information 210 may be represented using a square matrix (e.g., square matrix 212) of co-occurrence relations between all pairs of the constituent Gaussian distributions 206, a set of frequent itemsets (e.g., set 214), where each frequent itemset thereof represents a subset of constituent Gaussian distributions 206 that occur frequently (e.g., a frequency above a threshold 216) together, and/or a set (e.g., set 218) of co-occurrence relations between specific constituent Gaussian distributions 206 and a (hidden) data column 220 with a specified number of distinct integer values 222.

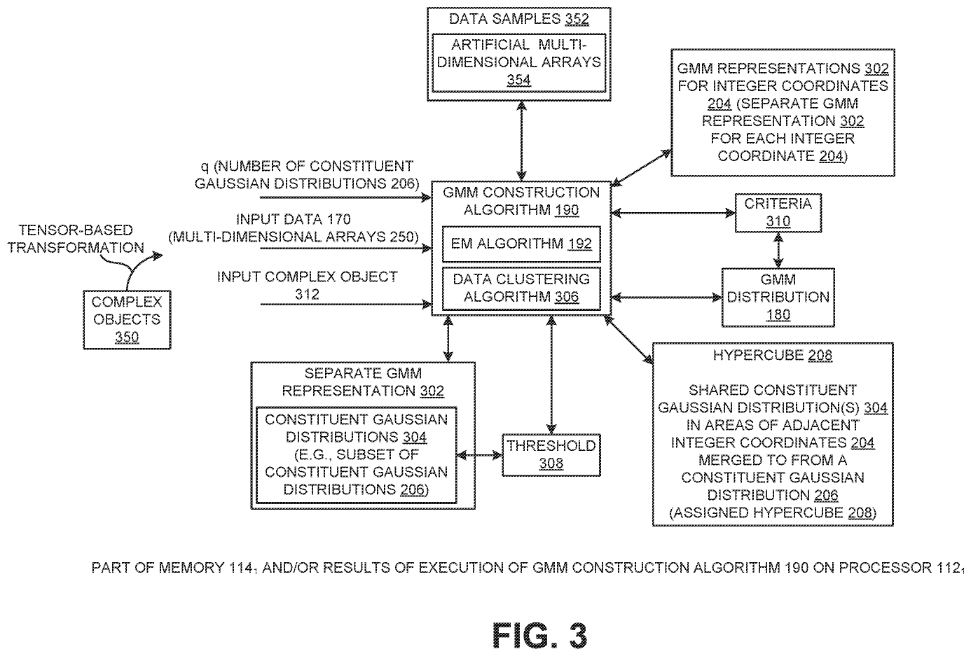

FIG. 3 shows derivation of GMM distribution 180 from the collection of multi-dimensional arrays 250 of input data 170, according to one or more embodiments. In one or more embodiments, GMM construction algorithm 190 may include or may be associated with an EM algorithm 192 that executes on memory 114₁ to build a separate GMM representation 302 for each integer coordinate 204 of integer coordinates 204 of multi-dimensional grid 202 from the collection/set of numeric values observed in the collection of multi-dimensional arrays 250 at the each integer coordinate 204. EM is known to one skilled in the art. In accordance with a typical EM algorithm (e.g., including EM algorithm 192), parameters of constituent Gaussian distributions of a GMM may be updated following estimating probabilities of the observed data (e.g., “observations”) input thereto. For each “observation,” the probability that said “observation” originates from each constituent Gaussian distribution may be computed. Further, parameters such as the mean of the constituent Gaussian distribution, variance/covariance and weights thereof that maximize an evidence lower bound for all “observations” given the aforementioned derived probabilities may be found. Detailed discussion of EM has been skipped for the sake of clarity and convenience.

In one or more embodiments, each separate GMM representation 302 may include a set of constituent Gaussian distributions (e.g., constituent Gaussian distributions 304) that may be a subset of the set of constituent Gaussian distributions 206. In one or more embodiments, processor 112₁ may execute a data clustering algorithm 306 (e.g., a bi-clustering algorithm that is part of GMM construction algorithm 190, external to GMM construction algorithm 190) to search for adjacent integer coordinates 204 that share one or more constituent Gaussian distribution(s) 304 in the separate GMM representations 302 associated therewith that are sufficiently similar (e.g., one or more similarity parameters being below a threshold 308) to one another.

In one or more embodiments, areas of adjacent integer coordinates 204 including the abovementioned adjacent integer coordinates 204 for which shared one or more constituent Gaussian distribution(s) 304 are found may form hypercube 208 in which the aforementioned shared one or more constituent Gaussian distribution(s) 304 are merged together to form a constituent Gaussian distribution 206. Thus, in one or more embodiments, each constituent Gaussian distribution 206 may be assigned a hypercube 208 of hypercubes 208, as discussed above. In one or more embodiments, constituent Gaussian distributions 206 of GMM distribution 180 may thus represent all hypercubes 208.

Thus, in one or more embodiments, during the data clustering discussed above, integer coordinates 204 may be replaced with a number of hypercubes 208 of clusters. In one or more embodiments, in the case of input data 170 being a transformation of image data 292 as shown in FIG. 2, image data 292 may represent, for example, an animal chasing another animal. The positions of the animals that reflect intensities across image data 292/input data 170 may occur together on a same image. In one or more embodiments, the correlations established above may indicate the aforementioned occurrence together. It should be noted that the same concepts may be extended to video data 294 (e.g., a time dimension may be extra) and/or time-series sensor data 296 discussed above. In one or more embodiments, input data 170 may also be an output of an autoencoder 298, as discussed above.

In one or more embodiments, the number of constituent Gaussian distributions 206, say, q, of GMM distribution 180 itself may be specified as an input parameter to the computation of GMM distribution 180 via GMM construction algorithm 190. In one or more embodiments, in scenarios where GMM distribution 180 with q constituent Gaussian distributions 206 does not approximate input data 170 well (e.g., inadequately based on predefined/dynamically defined criteria 310, other predefined/dynamically defined tests implemented in EM algorithm 192/EMM construction algorithm 190), EMM construction algorithm 190 may work with less than q constituent Gaussian distributions to generate GMM distribution 180 that does approximate input data 170 well.

In one or more embodiments, GMM distribution 180 may replace input data 170 in computing system 100/data processing device 102₁ and may be available as an approximate model of input data 170 for the purpose of any operations (e.g., based on executing ML algorithm 160) performed therein. In one or more other embodiments, GMM distribution 180 may be stored (e.g., as metadata) in memory 114₁ in addition to input data 170 and may be made available therethrough for the purpose of the aforementioned operations.

In one or more embodiments, as implied above, in input data 170, multi-dimensional arrays 250 may correspond to a collection of multi-dimensional numeric values of a data column of an array type in a data table distributed over consecutive rows stored in the data table. In one or more embodiments, multi-dimensional arrays 250 may also be split into smaller sets thereof. In one or more embodiments, GMM distributions analogous to GMM distribution 180 may be constructed (e.g., using GMM construction algorithm 190) and stored for all smaller sets, with a GMM distribution of the GMM distributions for each smaller set stored separately. In one or more embodiments, whenever it is required of operations (e.g., based on executing ML algorithm 160) executing on data processing device 102₁/computing system 100 to refer to GMM distribution 180, GMM distribution 180 may be constructed by merging together analogous GMM distributions of the smaller sets of multi-dimensional arrays 250. In one or more embodiments, the aforementioned merging may be based on modification of EM algorithm 192 that takes as an input thereof information about parameters of the analogous GMM distributions of the smaller sets of multi-dimensional arrays 250.

In one or more embodiments, the splitting of multi-dimensional arrays 250 into the smaller sets may be optimized in accordance with maximizing the ability of the analogous GMM distributions computed for the smaller sets to approximate original local distributions of array values within the smaller sets. As discussed above, multi-dimensional arrays 250 may be one or more output(s) of transformation of one or more complex objects 350. Examples of complex objects may include but are not limited to image data (e.g., image data 292), video data (e.g., video data 294), text data and/or time-series of sensor measurements (e.g., time-series sensor data 296). In one or more embodiments, the aforementioned transformation may involve a tensor decomposition (e.g., based on Tucker decomposition, CP decomposition) process and/or an internal layer (or output) of an autoencoder (e.g., autoencoder 298; a convolutional neural network or a neural network in general).

Here, in one or more embodiments, analogous GMM distributions of specific smaller sets of the one or more complex object(s) 350 may be stored (e.g., along with GMM distribution 180) in memory 114₁ instead of input data 170 or together with input data 170 relevant to the one or more complex object(s) 350 and/or input data 170 relevant to the output of the abovementioned transformation of the one or more complex object(s) 350. In one or more embodiments, an operation to be performed through data processing device 102₁/computing system 100 may require generation of one or more data sample(s) (e.g., data samples 352); the aforementioned operation may be related to learning one or more ML model(s) (e.g., implemented through ML algorithm 160) and/or data clustering. In one or more embodiments, data samples 352 may include artificial multi-dimensional arrays 354 of numeric values generated based on GMM distribution 180/the analogous GMM distributions.

In one or more embodiments, the generation of data samples 352 may be performed based on selecting the smaller sets of multi-dimensional arrays 250 by finding the analogous GMM distributions that are representative of the set of analogous GMM distributions of all smaller sets of multi-dimensional arrays 250. Here, in one or more embodiments, artificial multi-dimensional arrays 354 may be generated based on the analogous GMM distributions of the selected smaller sets of arrays and/or selecting an actual array belonging to the selected smaller sets of arrays therefor. In one or more embodiments, the choice of the analogous GMM distributions that are representative of the whole set of analogous GMM distributions may be based on an analysis of distances between said analogous GMM distributions. In one or more embodiments, the analysis of the distances may be based on a Wasserstein distance and/or a KL divergence. As discussed above, the Wasserstein distance and/or the KL divergence may be known to one skilled in the art. Detailed discussion thereof has, therefore, been skipped for the sake of convenience and clarity.

Here, in one or more embodiments, the assignment of hypercubes (e.g., analogous to hypercubes 208) to specific analogous constituent Gaussian distributions (e.g., analogous to constituent Gaussian distributions 206) of the analogous GMM distributions may be taken as an additional input to the analysis/computation of the distances.

In one or more embodiments, an operation to be executed on data processing device 102₁/computing system 100 may involve finding a subset of complex objects 350 that are most similar to a complex object (e.g., input complex object 312) specified as an input thereto. Here, in one or more embodiments, the search for most similar complex objects 350 may be performed in accordance with firstly transforming input complex object 312 into a corresponding numeric array or a multiple numeric array representation thereof. In one or more embodiments, the aforementioned representation may then be analyzed against the analogous GMM distributions of the specific smaller sets of complex objects 350 to determine the smaller sets that deliver a highest probability of contents thereof including similar complex objects 350. In one or more embodiments, a specific amount of smaller sets of complex objects 350 may then be selected and contents thereof explored to find the most similar complex objects 350.

In one or more embodiments, the operation to be executed on data processing device 102₁/computing system 100 may take as input thereto two data tables. In one or more embodiments, pairs of array data column types belonging to different data tables whose analogous GMM distributions are closest to one another may be found. Here, in one or more embodiments, the closeness of the analogous GMM distributions of the aforementioned pairs of data column types may be measured based on a Wasserstein distance and/or a KL divergence. In some embodiments, there may be at least two sources of complex objects 350. Here, GMM distributions (e.g., GMM distribution) of both sources may be built and compared to one another to verify whether said complex objects 350 coming from the at least two sources are semantically of the same type.

Thus, exemplary embodiments discussed herein provide for generation/computation of GMM distribution 180 for multi-dimensional arrays 250 (e.g., in the form of tensor-transformations). It should be noted that GMM distribution 180 may be computed from methods other than those discussed above. Last but not the least, drawing elements of FIGS. 2-3 are executable through processor 112₁, results of processing therethrough, inputs thereto and/or stored in memory 114₁, even if FIGS. 2-3 do not show one or more of the aforementioned explicitly. All reasonable variations are within the scope of the exemplary embodiments discussed herein.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., computing system 100, data processing device 102₁), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of approximating a data set comprising a collection of multi-dimensional numeric arrays with a Gaussian Mixture Model (GMM) distribution using a processor communicatively coupled to a memory, comprising:
distributing the data set across a multi-dimensional grid having integer coordinates associated therewith;
assigning a hypercube to each constituent Gaussian distribution of constituent Gaussian distributions of the GMM distribution as a subspace of the multi-dimensional grid to form a number of hypercubes; and
reducing a data footprint of the data set through the GMM distribution based on assigning the hypercube to the each constituent Gaussian distribution of the constituent Gaussian distributions of the GMM distribution.

2. The method of claim 1, further comprising representing correlation between intensities of occurrence of numeric values likely to be derived from a specific constituent Gaussian distribution of the constituent Gaussian distributions and specific integer coordinates thereof within the assigned hypercube based on at least one of:
regarding the numeric values likely to be derived from the specific constituent Gaussian distribution as occurring in an entirety of the corresponding hypercube assigned thereto;
assigning a set of the number of hypercubes forming a chain of consecutive subsets thereof to the same constituent Gaussian distribution of the constituent Gaussian distributions, but with different weights; and
regarding the specific constituent Gaussian distribution as a multi-dimensional Gaussian distribution and the integer coordinates of the specific constituent Gaussian distribution as additional numeric dimensions.

3. The method of claim 1, further comprising:
including information related to at least one of: an intensity of and a lack of co-occurrence of numeric values likely to be derived from different constituent Gaussian distributions of the constituent Gaussian distributions at different integer coordinates of the integer coordinates within a same array of the collection of multi-dimensional numeric arrays of the data set; and
representing the information related to the at least one of: the intensity of and the lack of co-occurrence of the numeric values using at least one of:
a square matrix of co-occurrence relations between all pairs of the constituent Gaussian distributions;
a set of frequent itemsets, each frequent itemset representing a subset of the constituent Gaussian distributions that occur together for a frequency above a threshold value thereof; and
a set of co-occurrence relations between specific constituent Gaussian distributions of the constituent Gaussian distributions and a data column with a specified number of distinct integer values.

4. The method of claim 1, further comprising deriving the GMM distribution from the data set in accordance with:
building a separate GMM representation of each integer coordinate of the integer coordinates of the multi-dimensional grid from the collection of multi-dimensional numeric arrays at the each integer coordinate to form a number of separate GMM representations in accordance with executing an EM algorithm using the processor communicatively coupled to the memory;
in accordance with executing a data clustering algorithm using the processor communicatively coupled to the memory, searching for adjacent integer coordinates of the integer coordinates that share at least one constituent Gaussian distribution in the separate GMM representations of the number of separate GMM representations associated therewith that are similar to one another based on a similarity parameter being below a threshold value thereof; and
forming, from areas of the adjacent integer coordinates, the hypercube in which the shared at least one constituent Gaussian distribution in the separate GMM representations are merged together to form the each constituent Gaussian distribution of the constituent Gaussian distributions of the GMM distribution.

5. The method of claim 1, further comprising:
specifying a first number of the constituent Gaussian distributions of the GMM distribution as an input parameter to a construction of the GMM distribution; and
working with a second number of the constituent Gaussian distributions of the GMM distribution that is less than the first number of the constituent Gaussian distributions in accordance with the GMM distribution inadequately approximating the data set.

6. The method of claim 1, further comprising:
the GMM distribution at least one of: replacing the data set and being available as an approximate model of the data set for an operation to be performed through the processor; and
storing the GMM distribution as metadata in the memory in addition to the data set for availability thereof for the operation to be performed trough the processor.

7. The method of claim 1, further comprising at least one of:
the collection of multi-dimensional numeric arrays corresponding to a collection of multi-dimensional numeric values of a data column of an array type in a data table distributed over consecutive rows stored in the data table;
splitting the collection of multi-dimensional numeric arrays into smaller sets thereof;
for each smaller set of the smaller sets, constructing GMM distributions analogous to the GMM distribution and storing a GMM distribution of the constructed analogous GMM distributions for the each smaller set separately in the memory; and
optimizing the splitting of the collection of multi-dimensional numeric arrays into the smaller sets in accordance with maximizing an ability of the constructed analogous GMM distributions to approximate original local distributions of array values within the smaller sets.

8. The method of claim 1, comprising at least one of:
the collection of multi-dimensional numeric arrays being an output of a transformation of at least one complex object;
the at least one complex object being at least one of: image data, video data, text data and time-series of sensor measurement data;
the transformation of the at least one complex object being at least one of: a tensor decomposition and an internal layer of an autoencoder; and
generating at least one data sample comprising artificial multi-dimensional numeric arrays based on the GMM distribution for an operation to be performed using the processor communicatively coupled to the memory.

9. The method of claim 7, further comprising at least one of:
the collection of multi-dimensional numeric arrays being an output of a transformation of at least one complex object;
the at least one complex object being at least one of: image data, video data, text data and time-series of sensor measurement data;
the constructed analogous GMM distributions of specific smaller sets of the at least one complex object being stored in the memory one of: instead of the input data and together with the input data relevant to at least one of: the at least one complex object and the output of the transformation of the at least one complex object;
generating at least one data sample comprising artificial multi-dimensional numeric arrays based on the constructed analogous GMM distributions for an operation to be performed using the processor communicatively coupled to the memory;
the operation to be performed using the processor communicatively coupled to the memory relating to at least one of: learning at least one Machine Learning (ML) model and data clustering;
generating the at least one data sample based on selecting the smaller sets by finding the constructed analogous GMM distributions that are representative of the constructed analogous GMM distributions of all the smaller sets; and
generating the artificial multi-dimensional numeric arrays at least one of: based on the constructed analogous GMM distributions of the selected smaller sets and selecting an actual numeric array belonging to the selected smaller sets.

10. The method of claim 9, further comprising at least one of:
choosing the constructed analogous GMM distributions that are representative of the constructed analogous GMM distributions of all the smaller sets based on an analysis of a distance between the constructed analogous GMM distributions;
the analysis of the distance being based on at least one of: a Wasserstein distance and a Kullback-Leibler (KL) divergence; and
taking as an additional input to the analysis of the distance assignment of hypercubes analogous to the hypercubes to specific analogous constituent Gaussian distributions of the constructed analogous GMM distributions.

11. The method of claim 9, further comprising:
the operation to be performed using the processing communicatively to the memory involving finding a subset of the at least one complex object that are most similar to another complex object specified as an input thereto in accordance with:
transforming the another complex object into a corresponding one of: a numeric array and a multiple numeric array representation thereof; and
analyzing the corresponding one of: the numeric array and the multiple numeric array representation against the constructed analogous GMM distributions of the specific smaller sets of the at least one complex object to determine the smaller sets that deliver a highest probability of contents thereof comprising objects similar to the at least one complex object.

12. The method of claim 9, further comprising:
the operation to be performed using the processor communicatively coupled to the memory taking as input thereto two data tables;
finding pairs of array data column types belonging to the two data tables whose constructed analogous GMM distributions are closest to one another; and
measuring closeness of the constructed analogous GMM distributions based on at least one of: a Wasserstein distance and a KL divergence.

13. A data processing device to approximate a data set comprising a collection of multi-dimensional numeric arrays with a GMM distribution, comprising:
a memory; and
a processor communicatively coupled to the memory, the processor executing instructions to:
distribute the data set across a multi-dimensional grid having integer coordinates associated therewith,
assign a hypercube to each constituent Gaussian distribution of constituent Gaussian distributions of the GMM distribution as a subspace of the multi-dimensional grid to form a number of hypercubes, and
reduce a data footprint of the data set through the GMM distribution based on assigning the hypercube to the each constituent Gaussian distribution of the constituent Gaussian distributions of the GMM distribution.

14. The data processing device of claim 13, wherein the processor further executes instructions to represent correlation between intensities of occurrence of numeric values likely to be derived from a specific constituent Gaussian distribution of the constituent Gaussian distributions and specific integer coordinates thereof within the assigned hypercube based on at least one of:
regarding the numeric values likely to be derived from the specific constituent Gaussian distribution as occurring in an entirety of the corresponding hypercube assigned thereto,
assigning a set of the number of hypercubes forming a chain of consecutive subsets thereof to the same constituent Gaussian distribution of the constituent Gaussian distributions, but with different weights, and
regarding the specific constituent Gaussian distribution as a multi-dimensional Gaussian distribution and the integer coordinates of the specific constituent Gaussian distribution as additional numeric dimensions.

15. The data processing device of claim 13, wherein the processor further executes instructions to:
include information related to at least one of: an intensity of and a lack of co-occurrence of numeric values likely to be derived from different constituent Gaussian distributions of the constituent Gaussian distributions at different integer coordinates of the integer coordinates within a same array of the collection of multi-dimensional numeric arrays of the data set, and
represent the information related to the at least one of: the intensity of and the lack of co-occurrence of the numeric values using at least one of:
a square matrix of co-occurrence relations between all pairs of the constituent Gaussian distributions,
a set of frequent itemsets, each frequent itemset representing a subset of the constituent Gaussian distributions that occur together for a frequency above a threshold value thereof, and
a set of co-occurrence relations between specific constituent Gaussian distributions of the constituent Gaussian distributions and a data column with a specified number of distinct integer values.

16. The data processing device of claim 13, wherein the processor further executes instructions to derive the GMM distribution from the data set in accordance with:
building a separate GMM representation of each integer coordinate of the integer coordinates of the multi-dimensional grid from the collection of multi-dimensional numeric arrays at the each integer coordinate to form a number of separate GMM representations in accordance with executing an EM algorithm,
in accordance with executing a data clustering algorithm, searching for adjacent integer coordinates of the integer coordinates that share at least one constituent Gaussian distribution in the separate GMM representations of the number of separate GMM representations associated therewith that are similar to one another based on a similarity parameter being below a threshold value thereof, and
forming, from areas of the adjacent integer coordinates, the hypercube in which the shared at least one constituent Gaussian distribution in the separate GMM representations are merged together to form the each constituent Gaussian distribution of the constituent Gaussian distributions of the GMM distribution.

17. A data processing device to approximate a data set comprising a collection of multi-dimensional numeric arrays, comprising:
a memory; and
a processor communicatively coupled to the memory, the processor executing instructions to:
distribute the data set across a multi-dimensional grid having integer coordinates associated therewith,
assign a hypercube to each constituent Gaussian distribution of constituent Gaussian distributions of a GMM distribution as a subspace of the multi-dimensional grid to form a number of hypercubes, and
utilize the GMM distribution:
to approximate the data set, and
one of: along with and instead of the data set for a computational operation using a Machine Learning (ML) algorithm also executing on the processor.

18. The data processing device of claim 17, wherein the processor further executes instructions to represent correlation between intensities of occurrence of numeric values likely to be derived from a specific constituent Gaussian distribution of the constituent Gaussian distributions and specific integer coordinates thereof within the assigned hypercube based on at least one of:
regarding the numeric values likely to be derived from the specific constituent Gaussian distribution as occurring in an entirety of the corresponding hypercube assigned thereto,
assigning a set of the number of hypercubes forming a chain of consecutive subsets thereof to the same constituent Gaussian distribution of the constituent Gaussian distributions, but with different weights, and
regarding the specific constituent Gaussian distribution as a multi-dimensional Gaussian distribution and the integer coordinates of the specific constituent Gaussian distribution as additional numeric dimensions.

19. The data processing device of claim 17, wherein the processor further executes instructions to:
include information related to at least one of: an intensity of and a lack of co-occurrence of numeric values likely to be derived from different constituent Gaussian distributions of the constituent Gaussian distributions at different integer coordinates of the integer coordinates within a same array of the collection of multi-dimensional numeric arrays of the data set, and
represent the information related to the at least one of: the intensity of and the lack of co-occurrence of the numeric values using at least one of:
a square matrix of co-occurrence relations between all pairs of the constituent Gaussian distributions,
a set of frequent itemsets, each frequent itemset representing a subset of the constituent Gaussian distributions that occur together for a frequency above a threshold value thereof, and
a set of co-occurrence relations between specific constituent Gaussian distributions of the constituent Gaussian distributions and a data column with a specified number of distinct integer values.

20. The data processing device of claim 17, wherein the processor further executes instructions to derive the GMM distribution from the data set in accordance with:
building a separate GMM representation of each integer coordinate of the integer coordinates of the multi-dimensional grid from the collection of multi-dimensional numeric arrays at the each integer coordinate to form a number of separate GMM representations in accordance with executing an EM algorithm,
in accordance with executing a data clustering algorithm, searching for adjacent integer coordinates of the integer coordinates that share at least one constituent Gaussian distribution in the separate GMM representations of the number of separate GMM representations associated therewith that are similar to one another based on a similarity parameter being below a threshold value thereof, and
forming, from areas of the adjacent integer coordinates, the hypercube in which the shared at least one constituent Gaussian distribution in the separate GMM representations are merged together to form the each constituent Gaussian distribution of the constituent Gaussian distributions of the GMM distribution.
